(19) United States
(12) Patent Application Publication
(10) Pub. No.: US 2025/0206101 A1
(43) Pub. Date: Jun. 26, 2025

(54) SYSTEM AND METHOD FOR PERSONALIZED VEHICLE HEATING, VENTILATION, AND AIR CONDITIONING SYSTEM

(71) Applicant: DENSO International America, Inc., Southfield, MI (US)

(72) Inventors: Yunfei XU, Milpitas, CA (US); Takafumi Okayasu, Cupertino, CA (US)

(21) Appl. No.: 18/392,844

(22) Filed: Dec. 21, 2023

(51) Int. Cl. B60H 1/00

(52) U.S. Cl. CPC B60H 1/0073; B60H 1/00742; B60H 1/00828; B60H 2001/00733

(57) ABSTRACT

A system in a vehicle includes sensors utilized to collect data at the vehicle, wherein at least one of the sensors is configured to identify a user, a HVAC system in communication with the plurality of sensors and configured to regulate a temperature of a cabin in the vehicle according to one or more HVAC settings; and a controller in communication with the plurality of sensors, the controller configured to receive and aggregate the data collected from the plurality of sensors, compare a current HVAC setting to a predicted HVAC setting customized to the user, wherein the predicted HVAC setting is updated in response to a machine learning model located at the vehicle, wherein the machine learning model is configured to output the predicted HVAC setting utilizing at least the aggregated data, and send instructions to the HVAC system to adjust the current HVAC setting to the predicted HVAC setting.

### TECHNICAL FIELD

The present disclosure relates to heating, ventilation, and air conditioning (HVAC) systems, including those found in vehicles such as an automobile.

### BACKGROUND

Vehicle cabin control has long been a manual operation. While there are automatic cabin features and multiple zones (e.g. dual climate control features, etc.), such settings still must be selected by a human user. Thus, changes in a driver, passenger, user, environment, may cause a user to select a temperature that is not typically set.

### SUMMARY

A first illustrative embodiment includes a method for controlling a vehicle cabin climate that includes receiving identification data at a vehicle, wherein the identification data identifies one or more users of the vehicle, receiving aggregated data from a vehicle, wherein the aggregated data relates to a plurality of inputs, wherein at least some of the data is acquired from input sources at the vehicle and some of the data is acquired from input sources located remotely from the vehicle. The method may utilize a machine learning model including a machine learning model at the vehicle to determine a cabin climate setting based on the aggregate data, wherein the machine learning model is updated with a trained version of the model utilizing the aggregated data, wherein the trained version of the model predicts a desired setting for the user, and controlling one or more climate features of the user of the vehicle according to the personalized-optimal cabin climate.

A second illustrative embodiment includes a system in a vehicle that has a plurality of sensors utilized to collect data at the vehicle, wherein at least one of the sensors is configured to identify a user in the vehicle. The system may include a HVAC system in communication with the plurality of sensors and configured to regulate a temperature of a cabin in the vehicle according to one or more HVAC settings, and a controller in communication with the plurality of sensors, the controller configured to receive and aggregate the data collected from the plurality of sensors, compare a current HVAC setting to a predicted HVAC setting customized to the user, wherein the predicted HVAC setting is updated in response to a machine learning model located at the vehicle, wherein the machine learning model is configured to output the predicted HVAC setting utilizing at least the aggregated data, and send instructions to the HVAC system to adjust the current HVAC setting to the predicted HVAC setting.

A third illustrative embodiment includes a computer-implemented method that comprises collecting data at the vehicle utilizing a plurality of sensors, wherein at least one of the sensors is configured to identify a user in the vehicle. The method may include utilizing an a HVAC system in communication with the plurality of sensors, regulating a temperature of a cabin in the vehicle according to one or more HVAC settings, and utilizing a controller in communication with the plurality of sensors receiving the data collected from the plurality of sensors, aggregating the data collected from the plurality of sensors, comparing a current HVAC setting to a predicted HVAC setting customized to the user, wherein the predicted HVAC setting is updated in response to a machine learning model located at the vehicle, wherein the machine learning model is configured to output the predicted HVAC setting utilizing at least the aggregated data, and sending instructions to the HVAC system to adjust the current HVAC setting to the predicted HVAC setting.

### BRIEF DESCRIPTION OF THE DRAWINGS

FIG. 1 is a system overview of a vehicle including a HVAC system according to one embodiment.

FIG. 2 illustrates a flow chart associated with one or more settings of a personalize HVAC model.

FIG. 3A illustrates a training phase associated with an HVAC system utilizing a machine learning model.

FIG. 3B illustrates a testing phase associate with an HVAC system utilizing a machine learning model.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

As disclosed below, a system and method for a cabin comfort learning and control system may include a personalized thermal comfort experience, without any user interaction with respect to the climate controls. The system may utilize incremental learning of a HVAC setting based on a particular user. Machine learning models may be utilized for the learning. The machine learning model may be located at the vehicle, in one embodiment. Thus, no internet connection is required to activate a personalized setting. Thus, the implementation may be edge-side (e.g. at the vehicle) to save on communication costs and data storage costs. Edge-side models may also be useful for protection of a user privacy policy. While automatic climate control is often referred to as automatically adjusting the HVAC system to reach a desired temperature in an efficient or graceful manner, in this embodiment, the automatic setting may be done without manual operating of the user or based on the behavior of the user.

In one embodiment, a HVAC system may be utilized that is capable of learning a user preference based on user interaction to the system. The HVAC system may automatically adjust the user setting based on the behavior of the user. The HVAC system may include a personalized machine learning model that is utilized for each individual driver. The HVAC system may also offer incremental learning from occasional user interaction. The HVAC system may also be implemented on the edge-side. Such an edge side implementation may train the machine learning model inside the vehicle in real-time, offer low latency and keep the model up to date, and increase privacy by not allowing user data to be transmitted to the cloud or off the vehicle.

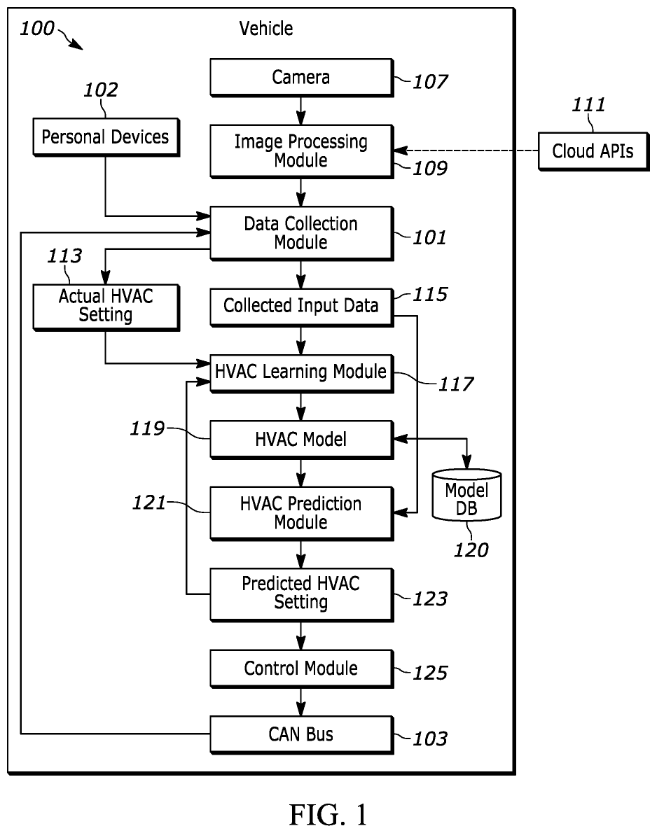

FIG. 1 is a system overview of a vehicle including a HVAC system according to one embodiment. Vehicle 100 may include a data collection module 101. The data collection module may include a controller that includes a memory with instructions stored therein. The data collection module 101 may collect data from an automotive network, such as a CAN bus 105. Such data may include the inside temperature of the cabin, the outside temperature of the vehicle environment, humidity, light-level (e.g. to measure sunlight), moisture, precipitation, etc. The data collection module 101 may also collect information from a user's personal devices 102, such as a wearable device (e.g. a smart watch that monitors health conditions). The wearable device can provide body temperature, heart rate, and other information to the vehicle. The personal devices 102 may also include a cellular phone, tablet, laptop, or any other device that a user may either bring into the vehicle or utilize. In another embodiment, the data collection module 101 may have a communication network with a cloud API 111 to collect certain data, such as weather/air quality API. The system may collect extracted information from an image processing module 109. The cloud API 111 may have a wireless connection to the vehicle and in turn the data collection module 101. Thus, the cloud API 111 may be remote from the vehicle.

In yet another embodiment, the data collection module may be in communication with an image processing module 109 that is in communication with a camera 107. The image processing module 109 may also be in communication with other types of sensors besides a camera, such as a radar, microphone, Lidar, etc. The image processing module 109 may receive data from one or more cameras 107 and extract the images captured by the cameras or other sensors. The images may include a digital photo, video, sound, radar, sonar, Lidar, or any other image information. The camera or other sensor may be located anywhere on or in the vehicle. For example, a front-view camera or radar may be located in or near a front bumper of the vehicle. The front-view camera may be utilized to identify a weather condition or road congestion information. Furthermore, the front-view camera may be utilized to identify vehicles and objects proximate the vehicle. In one example, if the road congestion is heavy, the model may infer that a user may want a temperature decrease. In another embodiment, a driver-facing camera may be located inside the vehicle cabin and utilized to identify a driver's garments. Thus, the driver-facing camera may utilize object recognition to identify a hat, gloves, jacket, types of clothing (e.g. sweater vs. shirt, vest, etc.), and other garments that a user may wear. The system can infer from the ambient temperature, vehicle cabin, and user's garments a personalized temperature to set in one embodiment. Thus, the data may be collected to analyze a personalized temperature.

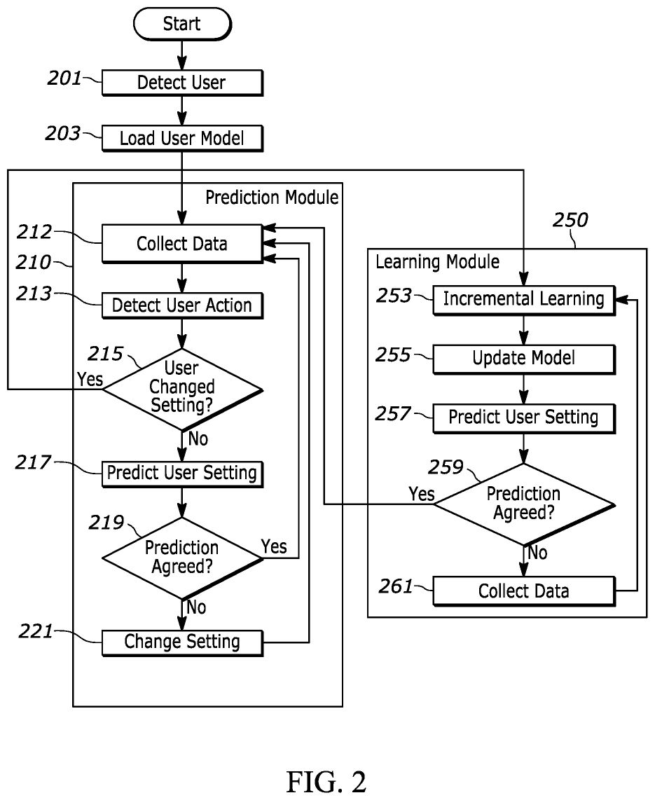

The collected input data 115 may be aggregated from the data of various sensors. Thus, the data may be combined and organized for utilization at the personalized machine learning model. The aggregated data may be sent to the HVAC learning module 117, in addition to the actual HVAC setting 113. The HVAC learning module 117 may determine if the setting needs to be adjusted or not (as discussed in more detail with FIG. 2 below). The HVAC learning module 117 may receive data from the data collection module 101 for specific drivers. The HVAC learning module 117 may receive data for a specific driver or user of the vehicle. The HVAC learning module 117 may be utilized to learn or train a machine learning model for predicting the user preferred HVAC settings in an incremental fashion. For training purposes, the learning module may also check if the current setting is appropriate with the predicted settings. If it is not, the learning module 117 may trigger the learning process.

The HVAC model 119 may be a machine learning model or machine learning model that can be trained to adjust a HVAC setting based on a user's environment and other surroundings. The HVAC model 119 may be a machine learning model that is continuously being updated and trained based on collected data. The HVAC model 119 may be in communication with a model database (DB) 120 that stores information pertaining to the user. In one embodiment, the HVAC model 119 may be personalized to a specific user. In another embodiment the HVAC model 119 may be pertaining to a certain demographic of user or just a general HVAC model that is crowd sourced based on several settings. For example, the general HVAC model may generalize a user's preference at a specific ambient temperature, cabin temperature, and amount of garment's worn.

The HVAC model 119 may be in communication with the HVAC prediction module 121. The HVAC prediction module may be utilized with the learned ML model to predict a user's preferred HVAC setting. The HVAC prediction module 121 can send the desired settings to the control module 125 for execution of the HVAC setting. The control module 125 may receive the predicted user setting and send the command to the CAN BUS 103 (or other automotive communication network), so that the vehicle ECU can execute the command. Thus, the command may include a preferred HVAC setting 123 that is executed at the HVAC system. The control module 125 may be one or more controllers that are either part of the HVAC system or that control the HVAC system. The HVAC preferred setting 123 may not require any human input to achieve such a setting. Thus, if the mode is activated, the system may automatically adjust temperatures of the cabin without a user setting a specific temperature of the cabin thermostat, such as state-of-the-art (or current) automatic HVAC settings. Thus in one embodiment, the HVAC model may change the cabin temperature to blow air at a lowest temperature (e.g. 60 degrees or 65 degrees) without a user setting any such temperature.

FIG. 2 illustrates a flow chart associated with one or more settings of a personalize HVAC model. The machine learning network of the vehicle may include a learning module 250 and a prediction module 210, which are described in detail below. At step 201, the system may utilize a controller that is utilized to detect a user. The system may utilize one or more sensors or data sources to identify the user. For example, a key fob of a driver may be utilized to identify a driver, or a personalized device (e.g. phone, watch, tablet, etc.). In another example, a vehicle seat setting may be utilized. In yet another example, an image collected from a vehicle cabin may identify a particular user. In yet another embodiment, a Bluetooth device (e.g., cellular phone or wearable device) may be utilized. The user may be any type of occupant in the vehicle, such as either a driver and/or passengers in the vehicle.

At step 203, the system may load the user model when it appears that the appropriate user is in the vehicle. If no user model is loaded, it may begin to start collecting information to create a personalized model. If a model is available, it may load that appropriate model associated with the user. The model may be utilized to indicate various settings and preferences for the user based on a variety of factors.

At step 211, the system may collect data via various sensors and collection methods. The collection of data may be utilized by the prediction module 210. The data collection may include collection of information from either in the vehicle or remote from the vehicle. The data attributable to ambient temperature, cabin temperature, weather may all be utilized. The data may be collected and aggregated for utilization at the model. The system may work with the prediction module 210 to detect a user action at step 213 based on the current setting at the vehicle. The system may evaluate such a user action to determine if an action has changed a temperature setting at 215. In one embodiment, if the user has changed the setting, the learning module 250 may be triggered to start incremental learning 253.

The learning module 250 may include a controller that is configured to utilize data aggregated from a plurality of input sources. At step 253, the system may utilize incremental learning to observe and collect data associated with the HVAC setting for a particular user and the surrounding environment. In one embodiment, any time a setting is adjusted, a number of data points are collected based on the HVAC setting and associated aggregated data associated with that HVAC setting for a particular user. For example, the aggregated data may include a vehicle cabin temperature, an ambient temperature, whether the user is wearing a jacket or not (via image data), a user heart rate, etc. If the HVAC setting is changed, the system may have monitored the duration of that HVAC setting that the user held that setting, in addition to the various data associated with that user.

Based on the data collected associated with the HVAC setting for a particular user, the system may update the model at step 255. The model may be updated based on the type of machine learning model that is utilized at the vehicle. For example, the machine learning model may include a deep neural network, convolutional neural network, or any other type of network. The model may be updated incrementally to mitigate any shock to a user's preferred settings. While the model may be updated incrementally, it may be working continuously to collect information to train a model for appropriate settings.

At step 257, the system may predict a user setting. The prediction may be based on the machine learning models features. The system may utilize the model to retrieve the various data for a specific driver/user and utilize the model for predicting the ideal temperature in incremental fashion. The learning module may be configured to determine if the current setting is inline with the predicted setting. At decision 259, the system may determine whether the prediction is agreed or not. The system may determine if a user changes the personalized setting within a threshold time to determine if the prediction was approved by the user. For example, if a certain HVAC feature is set and changed within one minute of updating by the user, the system may store information indicating that the user did not approve the setting for the current environment.

At step 261, the system may collect the data if a prediction is not agreed. Thus, the model may be updated to determine what the user's preference in such an environment is. Data will be collected from the various sensor sources to update the model. Thus, the learning module may not have identified a proper temperature and needs more time or data to identify an ideal source. The learning module must then continue to learn the user behaviors and temperature preferences to establish a working model that agrees with the user's preference. The system may either collect more data from the same sensors or utilize additional data from additional sensors.

If the prediction is agreed, the prediction module 210 may be triggered to collect data. More data will be collected at step 211 from the various sensors that are on the vehicle network (e.g. CAN bus). The data may be collected and aggregated for the model to utilize. Some of the data may indicate time-series data to identify when such data was collected in time. While data is being collected, the system may be continuously monitoring and being trained while the vehicle is on (e.g., battery on, ignition on, vehicle driving, etc.). The system may work with the prediction module 210 to detect a user action at step 213 based on the current setting. At decision 215, the system may determine if a user changed a setting associated with the HVAC system. If the user changed the setting, the system may trigger the learning module 250 to continue incremental learning at 253. Thus, it may be assumed that the user did not agree with the setting that was automatically initiated by the HVAC model. But if the user action is not associated with the HVAC setting, the system may continue to predict the user setting at 217. The HVAC module may work with the prediction module to predict a setting for a specific user based on a number of data points that are collected by in-vehicle sensors or collected remote the vehicle. After the prediction module predicts the user setting, it may determine if the prediction is appropriate based on the users action that did not change a user setting. If the prediction did not match, the prediction module may change the setting at 221. In one embodiment, the system may output a predicted user setting via a notification and ask a user to confirm the setting as appropriate. For example, an audible notification or notification on a user display may ask a user to confirm the setting. If the user accepts the setting, the system may make note of it and keep it. If the prediction is appropriate, the prediction module may continue to collect data at step 211. Thus, the system may constantly monitor the user's actions to determine if the user changed the settings or not to trigger the learning module or continue to predict the user setting without any learning.

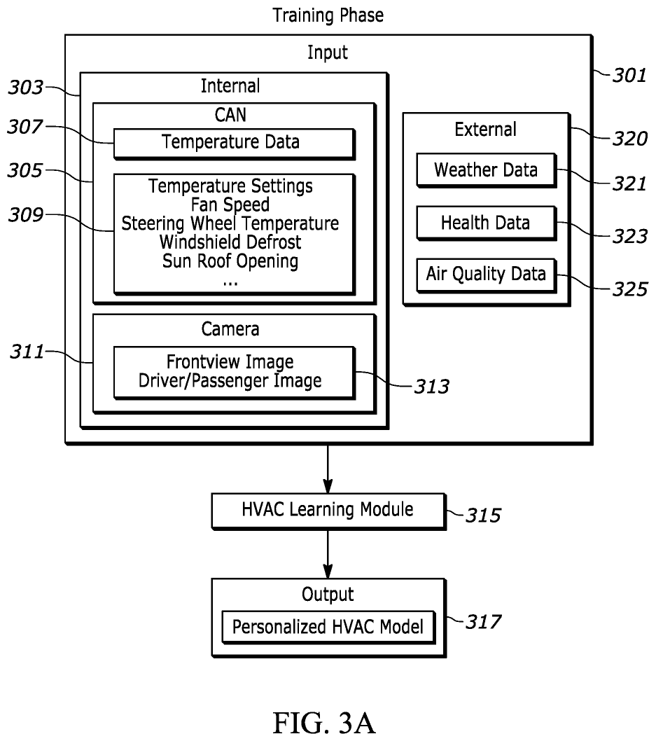

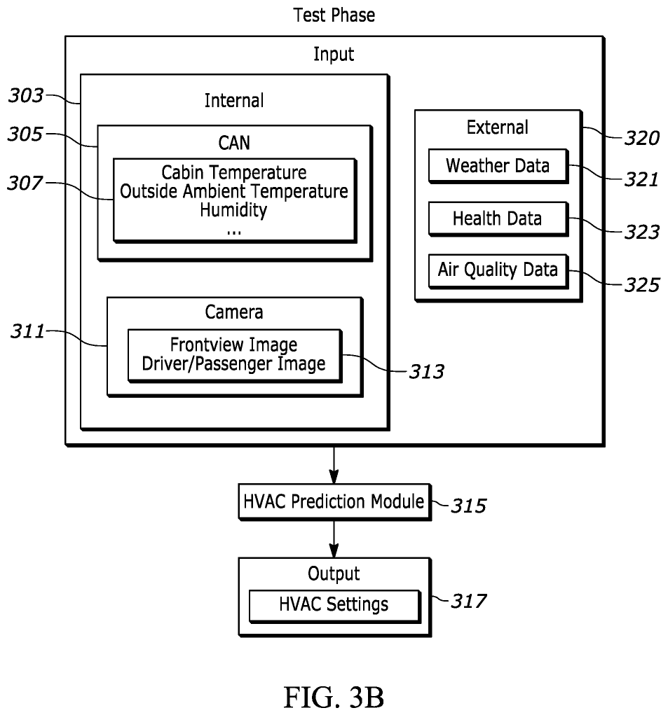

FIG. 3A illustrates a training phase associated with an HVAC system utilizing a machine learning model. Input sources 301 at the vehicle may be utilized at the vehicle to collect data that may be utilized to determine a preferred setting for HVAC controls. The input sources 301 may include both internal 303 and external 320 sources. For example, the internal sources 303 may include data and information located on the CAN network 305, or any other automotive communication network.

In one example, the CAN network 305 may communicate various temperature data 307 that are collected via sensors located in the vehicle and communicated on the CAN-bus. For example, the temperature data 307 may include cabin temperature, as collected by a thermostat or other sensor located in the vehicle cabin. In another example, the outside ambient temperature may be collected as part of the temperature data 307. The outside ambient temperature may be collected by a thermostat or other sensor located at the vehicle to measure the temperature outside of the cabin. In yet another embodiment, humidity data may be collected by a hydrometer or a humidity sensor located at the vehicle. Various types of humidity sensors are available, and these operate on different principles such as capacitive, resistive, semiconductor, optical, and surface acoustic waves. In one example, the humidity sensors may be of the electric resistance variable type that use hydrocarbon polyelectrolyte as a moisture sensing material. The humidity data may be collected to measure humidity at the vehicle cabin or the ambient humidity.

In another example, the CAN network may be in communication with sensors that include various settings associated with the vehicle. For example, the setting data 309 may include information regarding activation of certain features on the vehicle, such as heated seats or cooled seats. In one example, the system may include data associated with a current temperature setting associated with the HVAC setting. Thus, the system may collect data indicating the temperature being currently blown out of vents. In another example, the system may include data indicating a fan speed setting and a corresponding vent that the fan is associated with.

In another embodiment, the settings data 309 may include whether or not a steering wheel heater has been activated or not. Furthermore, it may indicate an associated temperature with a steering wheel. In yet another embodiment, the settings data 309 may indicate whether or not a windshield defroster has been activated or not.

In another embodiment, one or more camera sensors 311 may be utilized to take images or videos. The camera may be utilized to obtain images of the driver, passengers, or any occupant of the car. Furthermore, the camera may be utilized to measure sunlight and other visual features that may be utilized by the HVAC learning module 315. While the camera may be utilized for features to aid in the HVAC learning to create or train the model, the camera may be utilized to ensure the correct personalization is utilized. It may check occupant images with key fobs, seat settings, and other personalized settings to ensure a proper user is identified to customize the HVAC prediction model.

The sensors may include external sensors 320 that may be accessed or collected from remote sources via communication links at the vehicle. The external sources of data may include weather data 321. The weather data 321 may include information regarding the temperature, precipitation, cloudiness, humidity, etc. For example, the weather data 321 may indicate a precipitation amount of rain or snow at a current time or at a future time. The weather data 321 may be utilized to monitor the current or future temperatures to evaluate impact to a user's climate preferences. Thus, the humidity and other weather related information may be utilized at a current moment or future moment to anticipate adjusting an HVAC setting.

The health data 323 may be collected from one or more wearable devices, or other type of personalized device at the vehicle. The health data 323 may indicate various information, such as user body temperature, heart rate, or other conditions that may impact a preference on a setting. The health data 323 may be utilized in one scenario to indicate that the user has a higher heart rate (e.g. over 120 beats per minute (BPM)) and thus it may be optimal to make the vehicle cabin cooler. Thus, the system may increase fan speed and decrease an HVAC temperature.

The air quality data 325 may be utilized to indicate an air quality issue surrounding a vicinity of the vehicle. For example, the air quality data 325 may indicate a high level of pollution. Such a data indicator may require the personalize climate setting to enter a vehicle recirculation mode of the HVAC system, as opposed to bringing in outside air to the HVAC system for evaluation. Furthermore, allergen information may be utilize to activate a certain recirculation setting or not. In another embodiment, a filtering function may be utilized the HVAC system. Air quality data 325 may also effect which vents are activated at the vehicle.

The input data 301 may be aggregated from the various data sources (e.g., internal sources 303 and external sources 320). In one embodiment, once the data is aggregated, it may be sent to an HVAC learning module 315. The HVAC learning module may include a machine learning model utilized to train a model associated with personalized HVAC preferences for a specific user of the vehicle. Thus, the HVAC learning module 315 may be utilized to output the personalized HVAC model 317.

The machine learning network may be configured to provide an iterative function as a substitute for a stack of layers of the neural network to be trained during operation of the system. The machine learning network (e.g. machine learning model) may be a deep neural network, a convolutional neural network, or any type of artificial intelligence network. The respective layers of the stack of layers being replaced may have mutually shared weights and may have as input an output of a previous layer or, for a first layer of the stack of layers, an initial activation, and a portion of the stack of layers' input received. The processor subsystem may further be configured to iteratively train the neural network using the training data. Here, an iteration of training by the processor subsystem may include a forward propagation portion and a backward propagation portion.

The system may include an output interface for outputting a personalized HVAC model 317 or other type of data representation of the trained neural network, which may also be referred to as trained model data. For example, the output interface may consist of the data storage interface, where in these embodiments the interface is an input/output (“IO”) interface through which the trained model data may be stored in the data storage. For example, the data representation defining the ‘untrained’ neural network may be at least partially replaced during or after training by the data representation of the trained neural network, in the sense that the parameters of the neural network, such as weights, hyperparameters, and other types of neural network parameters may be adjusted to reflect training on the training data. In other embodiments, the data representation may be stored separately from the data representation that defines the “untrained” neural network. In some embodiments, the output interface may be separate from the data storage interface, but may generally be of a type as described above for the data storage interface. The output interface may be in communication with the HVAC system.

Upon being trained, the system may output the personalized HVAC model 317 to the HVAC system. The personalize HVAC model 317 may include various preferences and predictions based on the data collected, both from the internal sensors and external sensors. The personalized HVAC model 317 may include any combination of a target temperature, target fan speed, or target vent(s). The personalized HVAC model 317 may be utilized to continuously updated based on various actions, as described above.

FIG. 3B illustrates a testing phase associate with an HVAC system utilizing a machine learning model. The testing phase may be utilized to evaluate various models that are created by the HVAC prediction module. The test phase may utilize internally sourced data 303 and externally sourced data 320. During the test phase, the system may remove the ability for the system to update or change any settings automatically in order to test the nature of the predicted setting. Thus, the system may continuously train or update the model. The test phase portion may similar to the training phase, as shown in the FIGS. 3A and 3B, except that the test phase may continuously monitor user interactions as related

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

1. A method for controlling a vehicle cabin climate, comprising:
receiving identification data at a vehicle, wherein the identification data identifies one or more users of the vehicle;
receiving aggregated data from a vehicle, wherein the aggregated data relates to a plurality of inputs, wherein at least some of the data is acquired from input sources at the vehicle and some of the data is acquired from input sources located remotely from the vehicle;
utilizing a machine learning network including a machine learning model at the vehicle to determine a personalized-optimal cabin climate based on the aggregate data, wherein the machine learning model is updated with a trained version of the model utilizing the aggregated data, wherein the trained version of the model predicts a desired setting for the user; and
controlling one or more climate features of the user of the vehicle according to the personalized-optimal cabin climate.

2. The method of claim 1, wherein the machine learning network is not at a remote server.

3. The method of claim 1, herein the aggregated data is not sent to a remote server;

4. The method of claim 1, wherein the plurality of inputs includes one or more sensors configured to collect at least a cabin temperature or an ambient temperature.

5. The method of claim 1, wherein the plurality of inputs includes a wearable device associated with the user, wherein the aggregated data includes a heart rate associated with the user as determined by the wearable device.

6. The method of claim 1, wherein the plurality front driver facing camera is configured to capture an image utilized to identify one or more garments associated with the user, wherein the aggregated data includes the image utilized to identify one or more garments associated with the user.

7. The method of claim 1, wherein the machine learning model is constantly updated utilizing the aggregated data in response to the vehicle ignition or vehicle battery being on.

8. A system in a vehicle including:
a plurality of sensors utilized to collect data at the vehicle, wherein at least one of the sensors is configured to identify a user in the vehicle;
a HVAC system in communication with the plurality of sensors and configured to regulate a temperature of a cabin in the vehicle according to one or more HVAC settings; and
a controller in communication with the plurality of sensors, the controller configured to:
receive and aggregate the data collected from the plurality of sensors;
compare a current a heating, ventilation, and air conditioning (HVAC) setting to a predicted HVAC setting customized to the user, wherein the predicted HVAC setting is updated in response to a machine learning model located at the vehicle, wherein the machine learning model is configured to output the predicted HVAC setting utilizing at least the aggregated data; and
send instructions to the HVAC system to adjust the current HVAC setting to the predicted HVAC setting.

9. The system of claim 8, wherein the controller is further configured to evaluate if the user adjusts the predicted HVAC setting within a threshold time period, and when the user adjusts the predicted HVAC setting with the threshold time period, the machine learning model updates the predicted HVAC setting utilizing at least data collected from the plurality of sensors during the threshold time period.

10. The system of claim 8, wherein the plurality of sensors include at least one temperature sensor configured to measure the temperature of the cabin or an ambient temperature of the vehicle.

11. The system of claim 8, wherein in response to actions by the user at the HVAC system, the machine learning model is constantly updated utilizing the aggregated data.

12. The system of claim 8, wherein the predicted HVAC setting includes a machine learning model associated with a preferred setting compared to a vehicle environment.

13. The system of claim 8, wherein the machine learning model is a convolutional neural network.

14. A computer-implemented method, comprising:
utilizing a plurality of sensors, collecting data at the vehicle, wherein at least one of the sensors is configured to identify a user in the vehicle;
utilizing an a heating, ventilation, and air conditioning (HVAC) system in communication with the plurality of sensors, regulating a temperature of a cabin in the vehicle according to one or more HVAC settings; and
utilizing a controller in communication with the plurality of sensors:
receiving the data collected from the plurality of sensors;
aggregating the data collected from the plurality of sensors;
comparing a current HVAC setting to a predicted HVAC setting customized to the user, wherein the predicted HVAC setting is updated in response to a machine learning model located at the vehicle, wherein the machine learning model is configured to output the predicted HVAC setting utilizing at least the aggregated data; and
sending instructions to the HVAC system to adjust the current HVAC setting to the predicted HVAC setting.

15. The computer-implemented method of claim 14, wherein the predicted HVAC setting includes a target temperature, a target fan speed, and a target vent.

16. The computer-implemented method of claim 14, wherein one of the sensors includes a camera configured to capture an image of the user in the vehicle, wherein the image of the user is utilized to identify whether a garment is worn by the user.

17. The computer-implemented method of claim 14, the machine learning model is a deep neural network.

18. The computer-implemented method of claim 14, wherein the data collected from the plurality of sensors includes data indicating an ambient temperature at the vehicle and data indicating a cabin temperature.

19. The computer-implemented method of claim 18, wherein the data collected from the plurality of sensors includes weather data from a remote server.

20. The computer-implemented method of claim 14, wherein the machine learning model is in direct communication with a controller area network (CAN) of the vehicle.
